(19) United States
(12) Patent Application Publication
(10) Pub. No.: US 2005/0287989 A1
(43) Pub. Date: Dec. 29, 2005

(54) Authentication method for supporting mobile internet protocol system

(76) Inventor: Sung Gu Lee, Pyeonglack-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/027,078

(22) Filed: Dec. 30, 2004

(30) Foreign Application Priority Data
Jun. 29, 2004 (KR) 2004-49391

(51) Int. Cl. H04M 1/66

(52) U.S. Cl. 455/411

(57) ABSTRACT

An authentication method for supporting a Mobile IP system reduces an operational load on a mobile node while providing non-repudiation function, by adding an electronic signature using an individual certificate of a mobile node to a registration request message. The authentication method for a Mobile IP system is used in a network system having a plurality of agents and a mobile node. The mobile node receives an advertisement message from one agent of the plurality of the agents, and transmits a registration request containing an electronic signature to the agent corresponding to the advertisement message.

### FIELD OF INVENTION

The present invention relates to a mobile internet protocol (IP) system between a mobile station or a portable terminal and a host; and, more particularly, to a method for performing an authentication process of the mobile station or a portable terminal using a mobile (IP) system based on a public key encryption algorithm in an effective manner.

### DESCRIPTION OF RELATED TECHNOLOGY

Various types of information appliances such as a personal data assistant (PDA), a smart-phone, a portable internet terminal, an Internet TV and the like have been changing a computing paradigm from a conventional desktop PC to a portable mobile device in conjunction with wireless techniques such as Bluetooth, 802.11b and the like. In this new computing paradigm, a user is able to access desired information anywhere and/or anytime. Further, with recent remarkable progress in use of a wireless internet, by employing not only a conventional wired system but also a wireless system, an ability of people to access the internet for various services from a variety of different locations has been increased tremendously. Facing with the knowledge-information era, plural techniques related to such a computer and an Internet have been introduced to make it possible to freely access public knowledge and information from anybody, anywhere and anytime. Among the plural techniques, a mobile internet protocol (IP) technique is to provide a method for getting the public knowledge and information provided from an internal or external side of the user equipment by interconnecting the user equipment to other information host or other's equipments.

Recently, as a home networking technology is rapidly developed, home appliances such as a refrigerator, an oven and the like are coupled to an internet network. In accordance with plural advanced technologies related to the home networking technique, the mobile communication and the internet service, it seems that a digital life era, i.e., as a ubiquitous era, faster comes with the national-wide high-speed network. In order to support such a mobility feature, a specific IP system has been presented, with which it can be possible to provide a service continuously even when the wireless user temporally moves to another subnet.

### SUMMARY OF INVENTION

It is, therefore, an object of the present invention to provide an authentication method for supporting a Mobile IP system with which load on a mobile node can be effectively reduced while providing non-repudiation function, by adding an electronic signature using an individual certificate of the mobile node to a registration request message.

In accordance with an aspect of the present invention, there is provided an authentication method for supporting a Mobile Internet Protocol (IP) system for use in a network system having a plurality of agents and a mobile node, including the steps of: at the mobile node, receiving an advertisement message from one of the plurality of the agents; and at the mobile node, transmitting a registration request containing an electronic signature to the agent corresponding to the advertisement message.

In accordance with another aspect of the present invention, there is provided an authentication method for supporting a Mobile Internet Protocol (IP) for use in a network system having a plurality of agents and a mobile node, including the steps of: at one of the plurality of the agents, receiving a registration request containing an electronic signature from the mobile node; at the first agent, verifying with the electronic signature in response to the registration request and generating verification result as a proof for the receipt of registration request based on completion of verification; and at the first agent, generating a registration identification(ID) of the mobile node and storing the registration ID.

In accordance with another aspect of the present invention, there is provided an authentication apparatus for supporting a Mobile Internet Protocol (IP) system for use in a network system having a plurality of agents and a mobile node, including: a first block included in the mobile node for receiving an advertisement message from one of the plurality of the agents; and a second block included in the mobile node for transmitting a registration request containing an electronic signature to the agent corresponding to the advertisement message.

In accordance with another aspect of the present invention, there is provided an authentication apparatus for supporting a Mobile Internet Protocol (IP) for use in a network system having a plurality of agents and a mobile node, wherein an agent includes: a first block for receiving a registration request containing an electronic signature from the mobile node; a second block for verifying with the electronic signature in response to the registration request and generating verification result as a proof for the receipt of registration request based on completion of verification; and a third block for generating a registration identification(ID) of the mobile node and storing the registration ID.

### BRIEF DESCRIPTION OF THE DRAWINGS

The above and other objects and features of the present invention will become apparent from the following description of preferred embodiments taken in conjunction with the accompanying drawings, in which:

FIG. 1 is an operational flow chart showing a method for discovering any other agent, for use in a foreign agent;

FIG. 2 is an operational flow chart illustrating a registration request processing in a registration method for use in a foreign agent;

FIG. 3 is an operational flow chart demonstrating a registration response processing in a registration method for use in a foreign agent;

FIG. 4 is an operational flow chart depicting a registration request processing of a registration method for use in a home agent;

FIG. 5 is an operational flow chart describing an agent information managing method for use in a mobile node;

FIG. 6 is an operational flow chart explaining an agent discovering method for use in a mobile node;

FIG. 7 is an operational flow chart illustrating an operation of a mobile node in an authentication method for a Mobile IP system in accordance with an embodiment of the present invention;

FIGS. 8A and 8B are operational flow charts showing an operation of an agent in an authentication method for a Mobile IP system in accordance with an embodiment of the present invention;

FIG. 9A is a graph depicting a period that is required for authentication when a mobile node moves away from 1 km spot from a home network to 40 km spot from the home network;

FIG. 9B is a graph demonstrating a percentage of an authentication period to a stay period during which a mobile node keeps staying within a subnet having its size of 0.1 km;

FIG. 9C is a graph describing a percentage of an authentication period to a stay period during which a mobile node keeps staying within a subnet having its size of 0.5 km; and

FIG. 9D is a graph showing a percentage of an authentication period to a stay time during which a mobile node keeps staying within a subnet having its size of 1 km.

### DETAILED DESCRIPTION OF INVENTION

Hereinafter, an authentication method for a Mobile IP system in accordance with the present invention will be described in detail referring to the accompanying drawings.

In the wireless Internet environment, since location of a mobile station or a portable terminal is likely to change continuously, the Internet service provided in the conventional wired network should be supported in a system employing the mobility of the mobile station. As representative techniques for supporting the system employing the above mobility, there are Mobile Internet Protocol (IP), Wireless Transmission Control Protocol (W-TCP) and Mobile Ad-hoc NewoRk, MANET. Here, the Mobile IP is to provide the IP service no matter where the mobile node is within a predetermined network area. The W-TCP is to improve the conventional TCP to a proper form for the wireless network. The MANET is to support an environment where all the nodes move with no fixed infrastructure such as base station.

Among above described techniques, the Mobile IP has been developed to overcome the limitation of the host or the user equipment movement between subnets in network path configuration based on a network IP address. Except for the mobile IP, there was no solution capable of supporting movement between subnets. In order to continuously keep the host which moves to another subnet with connection to a network system, the host should be assigned to a valid IP address for used in the network system and should change the configuration of the host according to the valid IP address. However, this process can cause many inconveniences, e.g., a management of the IP address. In order to solve such a problem, Internet Engineering Task Force (IETF) has suggested another protocol of new Mobile IP referring to the internet's Request for Comments documentations series (RFC) 2002. This Mobile IP (RFC 2002) being a protocol of the wired core network is to provide mobility and is required essentially to support the wireless Internet. Presently, the 3rd Generation Partnership Project 2 (3GPP2) network employs this Mobile IP and the Universal Mobile Telecommunications System (UMTS) also uses this Mobile IP as its standard within the general packet radio service (GPRS).

In the Mobile IP, a two-tier address structure is employed as an address translation scheme in the IP layer. In other words, the first address is a Care Of Address (COA) for use in path distribution and transfer, and the other address is a Home Address (HA) being a static IP address of the mobile host, for use in host identification and a session connection. That is, the mobile host has the HA that is the unique Internet address corresponding to the host name as the conventional fixed host, and the COA that is the actual packet destination and is changed while the mobile host moves through the network.

Here, a mobile node may be a laptop computer, a desktop computer, a wireless terminal and so on which are capable of communicating via the network system. The mobile agent may be a router of each of a home or foreign network link. On the other hand, the home agent may be a router on the home network link of the node. The foreign agent may be a router on the foreign network link of the node. On the other hand, the COA is the address of the foreign agent that the mobile node possesses for communication with the home agent.

It will be described below for the operation of an exemplary Mobile IP system that can be used with the invention.

First, there is performed an agent discovery process.

In the agent discovery process, it is determined whether the current location of the mobile host is the home network or foreign network, or whether the mobile host moves from one network to another network. All the home agents or foreign agents periodically advertise that they can currently provide services by broadcasting the COAs within the access coverage of the respective links. Further, the mobile host may transmit an agent solicitation message to obtain the COA. The agent advertisement performs functions as follows:
facilitating discovery of the home agent or foreign agent,
listing the COA that the mobile host can obtain,
informing the mobile host of particular functions that are provided from the foreign agent,
determining the network to which the mobile host is currently connected is the home network or the foreign network.

Then, a registration process is performed.

In the registration process, the mobile host transfers information about the network to which the mobile host belong currently, to the corresponding home agent. Through the registration process, a new mobility binding including the home address, COA, registration valid time and the like of the mobile host is initially generated or updated. There are two possible scenarios for the registration, one in which the foreign agent transfers the registration request message of the mobile host to the home agent and the other one in which the mobile host directly transfers the registration request message to the home agent without trough any foreign agent.

Then, a tunneling process is performed.

In the tunneling process, after the mobile host is registered on the foreign agent and the home agent, datagram sent to the home network of the mobile host is intercepted by the home agent, and the intercepted datagram is transferred to the foreign agent that is registered depending on the COA of the mobile host. If the mobile host exists in the home agent, the datagram is transferred to the mobile host without tunneling. Otherwise, when the mobile host is in the foreign network, the datagram is encapsulated with the COA in the home agent and then transferred to the foreign agent.

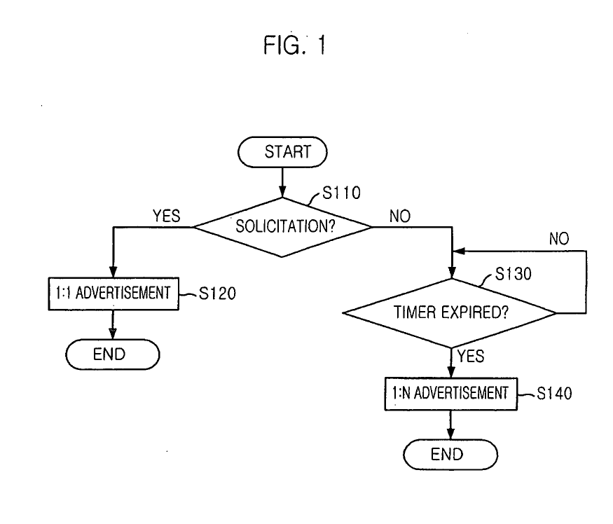

FIG. 1 is an operational flow chart for a typical method for discovering any other agent, for use in the foreign agent.

Referring to FIG. 1, first, it is determined whether the foreign agent receives the solicitation from the mobile node, in the step S110. If the foreign agent receives the solicitation from the mobile node, a 1:1 advertisement is transmitted (unicast) to the corresponding mobile node, in the step S120. If not receives, it is determined whether a predetermined time expires or not by using an internal timer. If the predetermined time has not expired, the decision for time expiration is repeated, in the step S130. If the predetermined time has expired, the 1:1 advertisement is transmitted (broadcast) to all the feasible mobile nodes (N mobile nodes), N being positive integer, in the step S140.

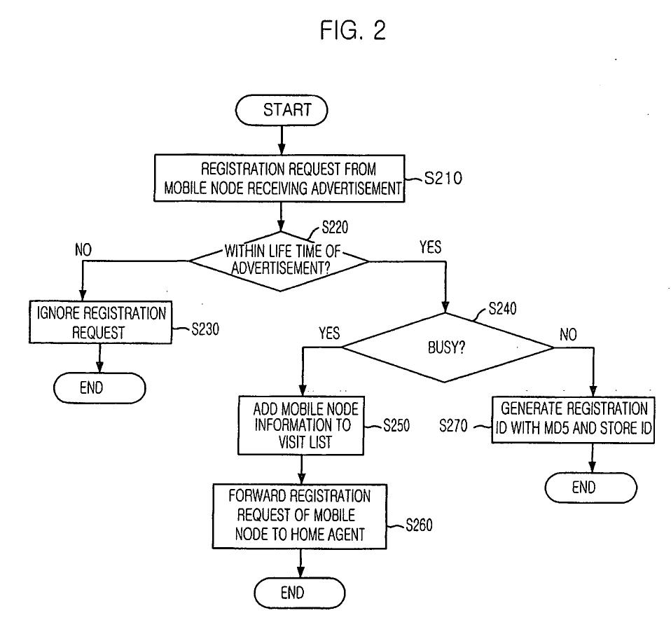

FIG. 2 is an operational flow chart demonstrating a registration request processing in a registration method for use in the foreign agent.

As shown, first, the foreign agent receives the registration request from the mobile node, in the step S210. Then, it is determined whether the registration request of the mobile node is within the life time of the advertisement that the foreign agent transmitted with the method as described above with reference to FIG. 1, in the step S220. If the registration request of the mobile node is received after the life time of the advertisement from the foreign agent expires, the registration request is ignored, in the step S230. Otherwise, when the registration request of the mobile node is received within the life time of the advertisement from the foreign agent, it is determined whether the current foreign agent is busy, i.e. it cannot perform the registration, in the step S240. If the current foreign agent is busy, information about the mobile node is added to a visit list, in the step S250. Then, the registration request of the mobile node is forwarded to the home agent, in the step S260. On the other hand, when the current foreign agent can perform the registration, a registration ID that is generated with the MD5 authentication method is stored, in the step S270.

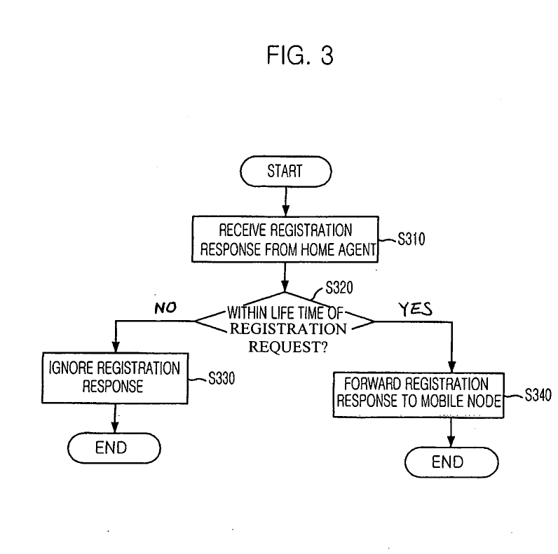

FIG. 3 is an operational flow chart illustrating a registration response processing procedure of a registration method in a foreign agent.

As shown, the foreign agent receives a registration response from the home agent to which the registration request was forwarded as described with reference to FIG. 2, and it is determined whether the registration response ID and the ID that the foreign agent sent are identical, in the step S310. Then, if the registration response ID and the ID that the foreign agent sent are identical, it is determined whether the registration request from the mobile node is within the life time of the registration request that was forwarded from the foreign agent to the home agent through the method as described with reference to FIG. 2 in the step S320. If the registration response from the home agent is received after the life time of the registration request that was forwarded from the foreign agent, the registration response is ignored, in the step S330. On the other hand, when the registration response from the home is received within the life time of the registration request that was forwarded from the foreign agent, the registration response is forwarded to the mobile node requesting the registration, in the step S340.

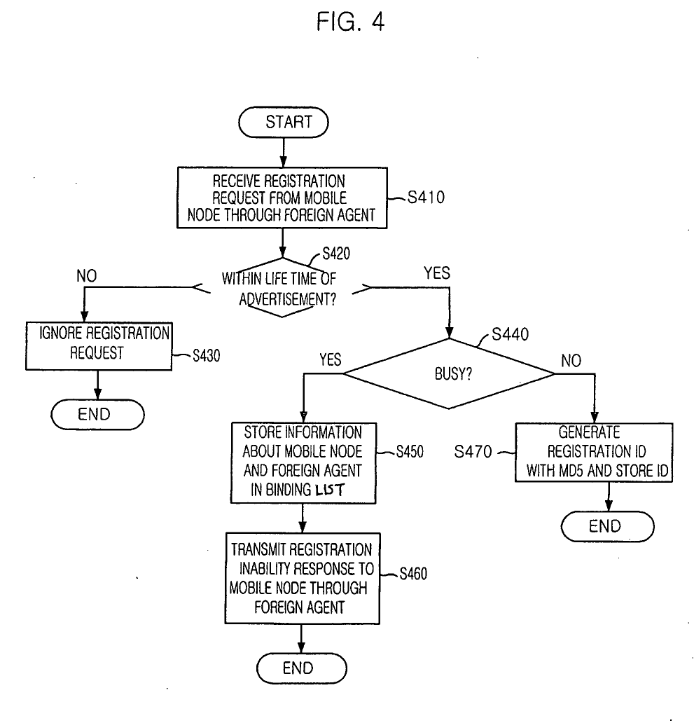

FIG. 4 is an operational flow chart describing a registration request processing in a typical registration method in the home agent.

As shown, first, the home agent receives the registration request from the mobile node via the foreign agent, in the step S410. Then, it is determined whether the registration request of the mobile node is within life time of the advertisement that the home agent transmitted, in the step S420. If the registration request of the mobile node is received after the life time of the advertisement from the home agent, the registration request is ignored, in the step S330. Otherwise, when the registration request of the mobile node is received within the life time of the advertisement from the home agent, it is determined whether the current home agent is busy, i.e. it cannot perform the registration, in the step S440. If the current home agent is busy, information about the mobile node and the related foreign agent is added to a binding list, in the step S450. Then, the registration response that says the registration cannot be performed is transmitted to the mobile node via the foreign agent, in the step S460. On the other hand, when the current home agent can perform the registration, the registration ID that is generated with the MD5 authentication method is stored in the step S470.

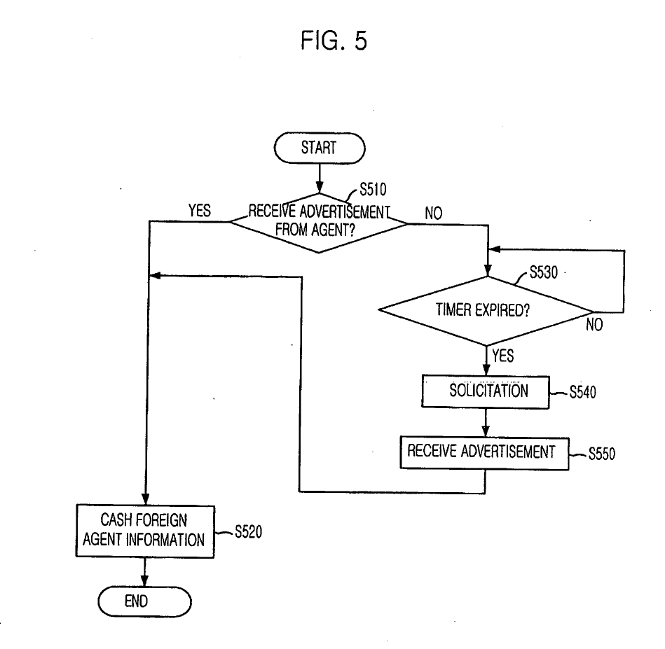

FIG. 5 is an operational flow chart depicting an agent information managing method for use in the mobile node.

As shown, first, it is determined whether the mobile node receives the advertisement from the home agent or foreign agent, in the step S510. If the mobile node receives the advertisement from the home agent or foreign agent, information about the corresponding home agent or foreign agent is stored in its internal cashe memory, in the step S520. If not receives, it is determined whether a predetermined time expires by using an internal timer. If the predetermined time has not expired, the decision for time expiration is repeated, in the step S530. If the predetermined time has expired, the mobile node transmits the solicitation message to foreign agents, in the step S540. Then, after receiving the advertisement from the home agent or foreign agent that receives the solicitation message, in the step S550, the mobile node stores the information about the corresponding home agent or foreign agent in its internal cashe memory, in the step S520.

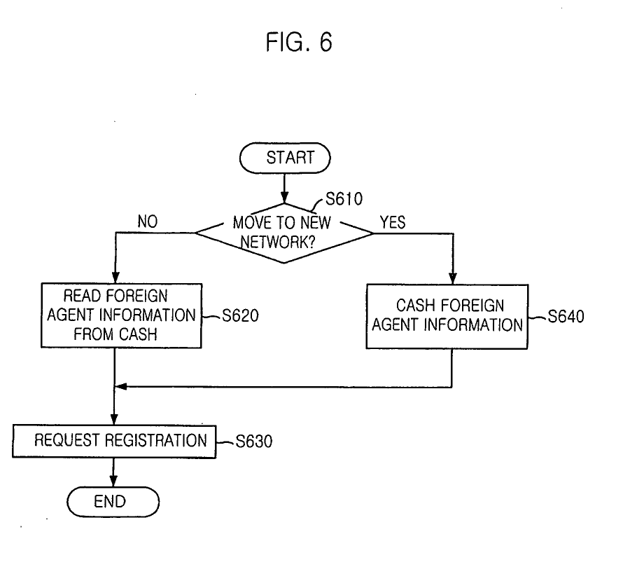

FIG. 6 is an operational flow chart illustrating an agent discovering method for use the mobile node.

As shown, first, it is determined whether the mobile node moves to another network, in the step S610. If the mobile node does not move to another new network, it reads the foreign agent information from the cashe memory, in the step S620. Then, the mobile node requests the registration to the corresponding to the foreign agent depending on the obtained information about the foreign agent, in the step S630. On the other hand, if the mobile node moves to the new network, it obtains information about the new network and stores this information into the cashe memory, in the step S640, and requests the registration to the corresponding foreign agent depending on the obtained information, in the step S630.

Further, the mobile node and agents may support reverse tunneling, for which “T” bit is set in the advertisement message expanded format of the foreign agent to indicate the reverse tunneling procedure, T being a positive integer. The mobile node informs that the Mobile IP system is provided through the reverse tunneling by setting the “T” bit in the registration request form and the foreign agent initiates the Mobile IP system through the reverse tunneling. Compared roughly the reverse tunneling to the typical tunneling, the reverse tunneling is similar to the typical tunneling until the mobile node receives a packet from a correspondent node except for serving with “T” bit, while there is a difference about which point the mobile node uses for transmitting the packet to the correspondent node.

For safe efficient provision of the Mobile IP system described above, the authentication process is very important during the ID registration steps S270 and S470. Now authentication methods such as private key based authentication mechanism, public key based authentication mechanism and minimal public key based authentication mechanism will be described.

First, the authentication methods are described in terms of authentication participants, i.e., mobile node, home agent and foreign agent.

In the private key based authentication mechanism, authentication is basically performed between the mobile node and the home agent. The mobile node appends its private key and a Message Authentication Code (MAC) for a protected field to the registration request to be authenticated from the home agent. On the other hand, the home agent is similarly authenticated from the mobile node in the registration response. However, the foreign agent as a participant in authentication only passively transfers received messages, which causes an incomplete security problem.

The public key based authentication mechanism performs the authentication for the counterpart whenever a message is transferred. Since the three participants, i.e., mobile node, home agent and foreign agent, of the registration process can reliably authenticate each other, this method is ideal in terms of security but repetitive authentications is likely to deteriorate performance.

In the minimal private key authentication mechanism, all the three participants, i.e., mobile node, home agent and foreign agent, take part in the authentication while reducing the number of authentications and overhead due to the private key authentication, with indirect authentication. When the foreign agent receives the registration request from the mobile node, it only checks if the value of the agent advertisement, that has been sent by itself, is valid without performing the authentication process. Since the mobile node receives the result of the authentication that is performed at the home agent without directly authenticating the foreign agent, it is possible to authenticate all the participants of the authentication with public key authentication effect. This method reduces performance deterioration by turning over the public key authentication for the foreign agent to the home agent while maintaining authentication of the foreign agent.

At this point, it is desirable that all the participants should be authenticated for secure authentication and, at the same time, the number of the repetitive public key authentications should be reduced to increase efficiency. Further, the mobile node should be made to perform the private key authentication of relatively simple computation.

On the other hand, as electronic exchange of documents becomes common, there are many problems due to document falsification or various defects. Accordingly, it is necessary to have an electronic signature on the document between a transmitter and a receiver, just like a signature or stamp on the typical paper document. Now authentication methods are described in terms of such an electronic signature.

In the private key based authentication mechanism, integrity of the document can be verified by using a timestamp to prevent the document from reused and authenticating with an authentication code that is created uniquely for the original document and added to the document. However, since the encryption key and the decryption key are identical, when the private key is leaked out, it happens that anybody can authenticate, i.e., there can be provided no non-repudiation function. Here, the characteristic that there is a unique one who can encrypt the document makes the provided service non-repudiated. This is called as non-repudiation function that can be obtained by the electronic signature to hold the mobile node responsible for using the network resources.

In the public key based encryption mechanism, integrity of the document can be also verified by using the timestamp to prevent the document from reused and authenticating with the authentication code that is added to the original document. In the public key based system, there is a pair of the private key and the public key, and only the public key is disclosed but the private key is known to only the owner of the private key no matter what. Accordingly, nobody can authenticate properly as long as the private key owner does not leak the private key. That is, this mechanism can provide the non-repudiation function.

In the minimal public key based authentication mechanism, expandability is improved with the public key while authentication related operations and public key calculations that the mobile node should perform are minimized. However, since the MAC is generated with the private key between the mobile node and the home agent, the non-repudiation function is defected. That is, since the electronic signature using the public key is exchanged between the foreign agent and the home agent, all that the network provided cannot be repudiated. Here, the home agent cannot repudiate the service that is provided to the mobile service, sending the electronic signature to the foreign agent with using the public key. However, in the environment such as electronic commerce for which high security is required, there can be happen a defect of non-repudiation service for location registration of the mobile node.

Finally, the authentication methods are described in terms of the encryption algorithm.

The authentication mechanism of the standard Mobile IP that is currently specified in IETF RFC2002 uses the hash function MD5 that is defined in RFC 1321 as private key based. The hash function is to output a safe bit string of a certain length for a given input bit string. In the hash code that is given as a function, which maps an input data string to an output hash code having a fixed length, it is almost impossible to calculate to find out the data string corresponding to a given hash code. Further, it is almost impossible to calculate to find out another data string that can generate to a hash code of a given data string. The MD5 algorithm is introduced to improve former MD4 algorithm that was developed by Ron Rivest in 1990, which makes a 128-bit hash code having a small size for less conflict. This is superior to the private key in terms of lower cost and faster calculation but has lower expandability due to the fact that the private key should be previously distributed between the mobile node and the home agent.

On the contrary, in the public key authentication mechanism, the mobile node is requested to perform public key encryption based on a certificate. The public key based authentication mechanism is disclosed in IETF draft. Among various algorithms, not limited to, Rivest-Shamir-Adelman (RSA) using a 512-bit key is suggested. No matter how secure, this has some problems such as certificate verification for verifying the certificate, which will charge high cost for encryption/decryption and, finally, deterioration in performance of the mobile node. Particularly, considering that the public key operation generally has 100-1000 times complexity than the private key operation, the public key based method imposes too much burden. At the mobile node having generally limited resources, a certificate issue operation should be a heavy task. In the public key based authentication mechanism, the mobile node should wait for certificate verification result by accessing an authentication authority only at the registration step, for issue of the certificate. However, it is difficult to perform such an operation because the mobile node generally has limited resources to provide insufficient power to use for calculation, and it takes longer time to exchange the message with the authentication authority as it moves away from the home network.

In the minimal public key based authentication mechanism, the mobile node need not access the authentication authority to obtain the certificate and access a Certificate Revocation List (CRL) to validate the certificate. The authentication between the mobile and the home agent is performed with the private key while the authentication between the foreign agent and the home agent, both having sufficient resources, is performed with the public key. Accordingly, it is efficient for the mobile node having limited resources to authenticate using the simple hash function and for the foreign agent or home agent having sufficient resources to authenticate with the public key.

In other words, with the private key based authentication mechanism, higher efficiency can be obtained with simple private calculation. However, authentication for all the participants cannot be accomplished and, due to nature of the MAC, non-repudiation service is defected.

With the public key based authentication mechanism, non-repudiation service can be provided to all the participants based on the public key. However, it takes too long time to apply actually.

In the minimal public key based authentication mechanism, the private key is used to maintain reliability between the mobile node and the home agent while the foreign agent and the home agent authenticate based on the public key. With this mechanism, no electronic signature is used between the mobile node and the home agent, which leads defect of non-repudiation function.

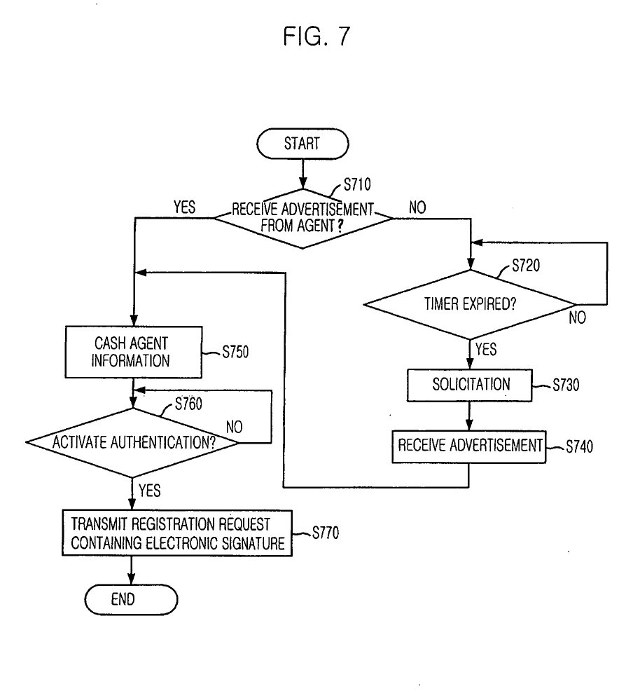

FIG. 7 is an operational flow chart showing a registration request operation of a mobile node in an authentication method for a Mobile IP system in accordance with an embodiment of the present invention.

As shown, it is determined whether the mobile node receives an advertisement from a foreign agent or home agent, in the step S710.

If the mobile node does not receive the advertisement from the foreign agent or home agent, it is determined whether a predetermined time expires by using an internal timer and, if not expires, this time expiration is checked repeatedly, in the step S720.

If the predetermined time expires, the mobile node transmits a solicitation message to the foreign agent or home agent, in the step S730.

Then, the mobile node receives an advertisement message from the foreign agent or home agent that received the solicitation message, in the step S740.

After the mobile node receives the advertisement from the foreign agent or the home agent, the mobile node then stores information related to the corresponding foreign agent or home agent into its internal cashe memory, at the step S750.

Then, the mobile node determines whether authentication related operation has to be activated with an external selection and, if the authentication operation should not be activated, this determination is performed repeatedly, in the step S760.

Then, if the authentication operation should be activated, the mobile node requests its registration with an electronic signature to the corresponding agent depending on the obtained information about the foreign agent or home agent, in the step S750. That is, the mobile node transmits a registration request containing the electronic signature to the agent that is set by the advertisement. Here, not limited to, the electronic signature can be generated with using a private key of the mobile node and the mobile node may possess a pre-issued certificate.

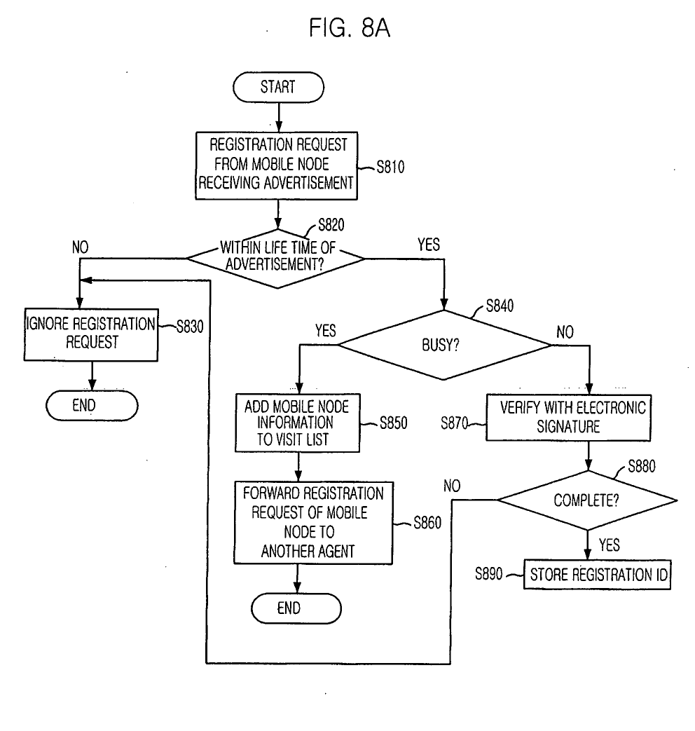

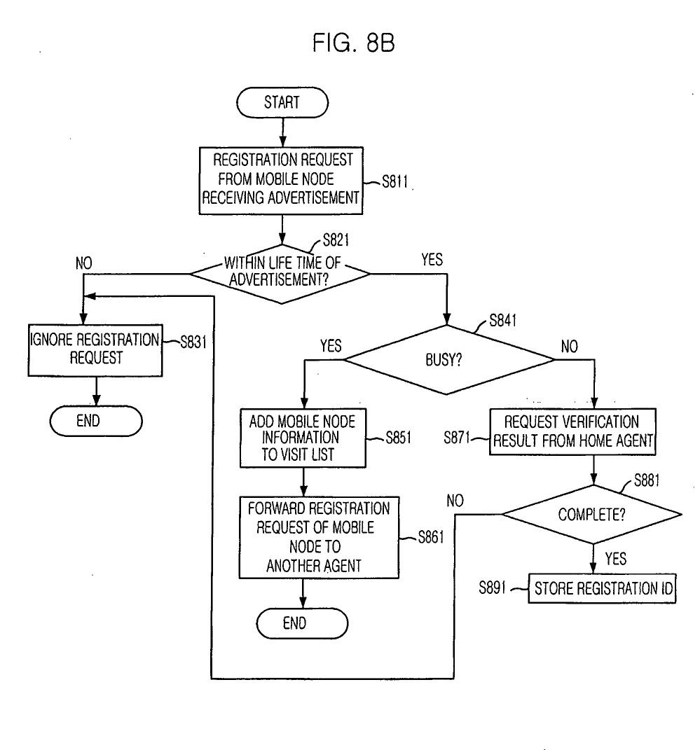

FIG. 8A is operational flow chart illustrating the operation of the home agent in the authentication method for a Mobile IP system in accordance with an embodiment of the present invention.

As shown, first, the home agent receives the registration request containing the electronic signature from the mobile node, in the step S810.

Then, it is determined whether the registration request containing the electronic signature of the mobile node is within the life time of the advertisement that the home agent transmitted, in the step S820.

If the registration request containing the electronic signature of the mobile node is after the life time of the advertisement that the home agent transmitted, the registration request is ignored, in the step S830.

On the other hand, if the registration request containing the electronic signature of the mobile node is within the life time of the advertisement that the home agent transmitted, it is determined whether the current home agent is busy, i.e., it cannot perform the registration operation, in the step S840.

If the current home agent is busy, information about the mobile node is added to a visit list, in the step S850.

Then, the registration request containing the electronic signature of the mobile node is forwarded to another agent, in the step S860.

On the other hand, if the current home agent is not busy, the home agent accesses an authentication authority with using the electronic signature to perform a verification process, in the step S870.

Then, the home agent determines whether the authentication process has been completed through the verification process, in the step S880.

If the authentication process has been completed, the home agent generates a verification result as a proof of the registration request and the home agent which stores the verification result generates a registration ID of the mobile node and stores the registration ID, in the step S890. That is, the generated registration ID can be stored with using the MD5 authentication method. Here, the verification result can be, but not limited to, in the form of a flag indicating completion of the verification and be stored in a memory within the home agent.

On the other hand, if the authentication process has not been completed, the registration request is ignored, in the step S830.

At this point, the home agent may transmit a registration response to the mobile node, informing that storage of the registration ID is completed (not shown). Here, the registration response can be, but not limited to, in the form of a message authentication code (MAC) using a private key.

FIG. 8b is an operational flow chart depicting the operation of the foreign agent in the authentication method for the Mobile IP system in accordance with an embodiment of the present invention.

Referring to FIG. 8B, first, the foreign agent receives the registration request containing the electronic signature from the mobile node, in the step S811.

Then, it is determined whether the registration request containing the electronic signature of the mobile node is within the life time of the advertisement that the foreign agent transmitted, in the step S821.

If the registration request containing the electronic signature of the mobile node is after the life time of the advertisement that the foreign agent transmitted, the registration request is ignored, in the step S831.

On the other hand, if the registration request containing the electronic signature of the mobile node is within the life time of the advertisement that the foreign agent transmitted, it is determined whether the current foreign agent is busy or not, in the step S841.

If the foreign agent is busy, information about the mobile node is added to a visit list, in the step S851.

Then, the registration request containing the electronic signature of the mobile node is forwarded to another foreign agent, in the step S861.

On the other hand, if the foreign agent is not busy, the foreign agent requests information including the verification result and the electronic signature from the home agent, in the S871. That is, the foreign agent requests the verification result that the home agent stores when the authentication process is completed as shown in FIG. 8a.

Then, the foreign agent determines whether the proper authentication process has been previously completed at the home agent through the verification process, based on the verification result and the electronic signature, in the step S881. Here, the foreign agent performs the authentication process only by checking whether the authentication process has been completed, based on the verification result, without accessing any authentication authority, and simply checking coincidence of the electronic signature.

If the authentication process has been completed, the foreign agent or home agent stores the verification result as the proof of the receipt of the registration request and the home agent which stores the verification result generates the registration ID of the mobile node and stores the registration ID, in the step S891. That is, the generated registration ID may be stored with using, but not limited to, the MD5 authentication method.

On the other hand, if the authentication process has not been completed, the registration request is ignored, in the step S831.

It will be described for an example in which the method for authenticating the Mobile IP system of the present invention is applied to a mobile node, foreign agent and home agent.

In an environment such as electronic commerce for which the responsibility of the mobile node action is heavy, there should be provided non-repudiation service for location registration. Accordingly, in authentication, the user should not be allowed to repudiate the resources and the actions that the user took in the network and the registration should be processed in a short time for the sake of user's convenience and smooth usage of network.

The method for authenticating the Mobile IP system of the present invention uses the public key based authentication mechanism and the minimal public key based authentication mechanism together. The method of the present invention is similar to the minimal public key based authentication mechanism except that the mobile node adds the electronic signature to the registration request. The foreign agent indirectly authenticates with the verification result from the home agent. The mobile node sends the electronic signature to the home agent and the home agent accesses the authentication authority to verify the electronic signature. From this, the home agent can authenticate both of the mobile node and the foreign agent. Here, the electronic signature of the mobile node provides the non-repudiation function that is important for location information that the mobile node registered. On the other hand, the home agent is authenticated by the foreign agent by sending the electronic signature to the foreign agent, while it is directly authenticated by the mobile node by sending the MAC to the mobile node. As such, all the participants in a new location registration process can be authenticated.

The mobile node generates the electronic signature with its own private key and adds the electronic signature to the registration request. Since the mobile node has the previously issued certificate, the mobile node need not access the authentication authority for every electronic signature to add the electronic signature and the certificate to the original document. The home agent receives and verifies the electronic signature and stores it as the proof of service request from the mobile node.

Though the registration request uses the electronic signature, the mobile node need not access the authentication authority when it receives the registration response but authenticate the response with the previously distributed private key, since the registration response depends on the MAC. Such a mechanism minimizes public key handling of the mobile node.

The followings are advantages of the method of the present invention compared to the public key based authentication mechanism.

First, it reduces performance deterioration of the mobile node by including the MAC using the private key in the registration response from the home agent. The hash function has much benefit in the environment such as the mobile node that should minimize calculation. In other words, after the home agent stores the registration ID in the step S890, the home agent sends the registration response including the MAC using the private key. Such a MAC using the private key reduces calculation load compared to the MAC that is applied to the registration response process (see FIG. 3).

Second, the mobile node need not verify the foreign agent when it receives the agent advertisement and need not perform the authentication process directly with the foreign agent during the registration. When the home agent receives the registration request and authenticates the foreign agent, it sends the registration response to the mobile node if the authentication succeeds. When the mobile node receives the registration response, it can indirectly authenticate the foreign agent.

Third, the mobile node generates the electronic signature with one public key operation. The mobile node need not access the authentication authority since it generates the electronic signature with its own private key. From this, the mobile node can save power from reduced calculation. Further, when the mobile node receives the registration response, it authenticates the response with the previously distributed private key, with less calculation cost without accessing any authentication authority.

Such a new minimal public key authentication mechanism using the electronic signature corresponds to a new location registration step for providing a future data communication path when the mobile node moves. Accordingly, this inventive method can prevent an ill-intentioned user from attacking in the sense that all the participants involved in the authentication can be authenticated in establishing a new path for communication. At the same time, authentication integrity can be ensured with authentication algorithm such as MD5 and RSA, which are used for the private key mechanism and the public key mechanism.

Particularly, the non-repudiation service for the new location registration action can be provided in the RSA since only the mobile user has the private key. This method provides the non-repudiation function for the network resource user when the new network path is set in the network for which security is highly required, which is different from the non-repudiation function for the document and data using the electronic signature in the applications.

As described above, there can be provided a mobile protocol that can improve the authentication performance by authenticating all the participants with minimal usage of the public key and can be used in the network having systems for which security is highly required by including the non-repudiation service for the mobile node.

Further, when the mobile node that was offline is to again register on the same FA, this registration can be optimized. That is, the electronic signature may be made during idle period of the mobile node so as to immediately use in the next registration, which will reduce the entire registration time.

It will be described below for the performance analysis of the authentication method for the Mobile IP system according to the present invention.

The modeling corresponds to the step of registering the new mobile node information on the foreign agent when the mobile node moves into a new subnet and receives a specific message such as agent advertisement.

TABLE 1

| | | | | Public key electronic | |
|---|---|---|---|---|---|
| | | Hash function | | Signature | |
| | | Encryp- | Decryp- | Encryp- | Decryp- |
| | | tion | tion | tion | tion |
| Private | All | 2 | 2 | | |
| Key | Mobile | 1 | 1 | | |
| (SK) | Nodes | | | | |
| Public | All | | | 10 | 11 |
| Key | Mobile | | | 1 | 4 |
| (PK) | Nodes | | | | |
| Minimal | All | 2 | 2 | 4 | 4 |
| Public | Mobile | 1 | 1 | | |
| key | Nodes | | | | |
| Present | All | 1 | 1 | 6 | 5 |
| Invention | Mobile | | 1 | 1 | |
| | Nodes | | | | |

Since encryption/decryption takes a very important part of the authentication mechanism, its effect within the authentication mechanism may be analyzed by computing the number of performances for each (as shown in Table 1) and an authentication average time. The number of encryption/decryptions that are required in each authentication mechanism is presented in Table 1. Here, equations that are used to compute numerically simulation result are as follows. Here, the entire registration time T is a sum of node processing time, Operation, including time for generating the registration request and the registration response and time for updating the table in each agent, transfer delay time, Delay, for transferring a message between the node and the agent, and encryption/decryption time, EncrypDecrypTime, for creating the MAC or the electronic signature.
T=Operation+Delay+EncrypDecrypTime Eq. (1)
Delay=PropDelay+TransDelay Eq. (2)
EncrypDecrypTime=EncrypTime+DecrypTime Eq. (3)
EncrypTime=SecretEncryp+PublicEncryp Eq. (4)
DecrypTime=SecretDecryp+PublicDecryp Eq. (5)

The transfer delay time, Delay, is the sum of the propagation delay, PropDelay, due to the distance between the authentication participating nodes, and the transmission delay, TransDelay, due to the medium. The time required for encryption and decryption includes the encryption time, Encryptime, and the Decryption time, Decryptime. The encryption time, encrypTime, includes the private key based encryption time, SecretEncryp, and the public key based encryption time, PublicEncryp. The MD5 is used as the private key and the RSA is used as the public key. Similarly, the decryption time, DecrypTime, includes the private key based decryption time, SecretDecryp, and the public key based decryption time, PublicDecryp.

The number of the hash function calculations is 4 for the private key. The number of the hash function calculations is 21 for the public key, which is more than 5 times of private key. Considering that the public key calculation typically takes 100-1000 times longer time than the private key calculation, it takes much longer time and much more cost to calculate the public key compared to the private key. When the public key calculation is minimized as in the minimal public key mechanism, more than half of the costly public key calculations can be saved. Particularly, the mobile node only need calculate the private key. In the method for authenticating the Mobile IP system according to the present invention, the number of public key calculations is significantly reduced even to once, though the number of the public key calculations is increased little bit due to addition of the electronic signature for the non-repudiation service.

TABLE 2

| | MAC | | Electronic signature | |
|---|---|---|---|---|
| | Generation | Verification | Generation | Verification |
| Average | 0.21 | 0.17 | 80.38 | 10.08 |
| time | | | | |

Referring to Table 2, there is shown the average time required to generate and verify the authentication code. It takes 0.208 ms to generate the MAC and 0.167 ms to verify the MAC. There is substantially no difference between them since the mechanisms for generating and verifying the MAC are identical. On the other hand, it takes 80.38 ms to generate the electronic signature, which is longer than 10.08 ms for verification. The reason why it takes 48-473 times longer time to generate the electronic signature than the MAC is complexity in the structure of the public key function itself. The public key calculation requires more cost, more resources and more power consumption. Further, there is costly procedure such that the public key should be placed in charge of a key manager after it issued and redistributed to use in decryption as well as it takes long time to encrypt/decrypt the public key.

The Mobile IP is suitable to support macro mobility but there will be much overhead if it is used under micro mobility, i.e., moving between wireless trans-receivers, each having very small coverage. Accordingly, assuming the Mobile IP is based on macro mobility, the authentication time is calculated depending on location of the mobile node.

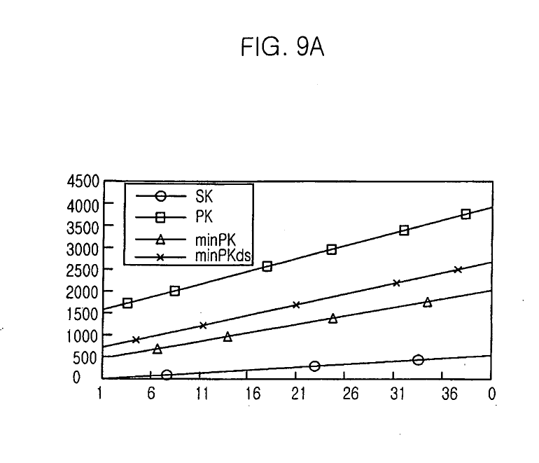

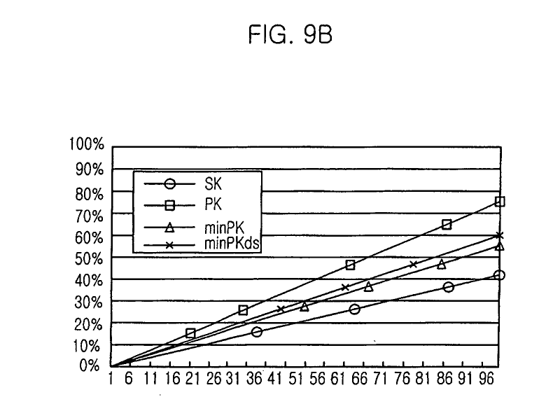

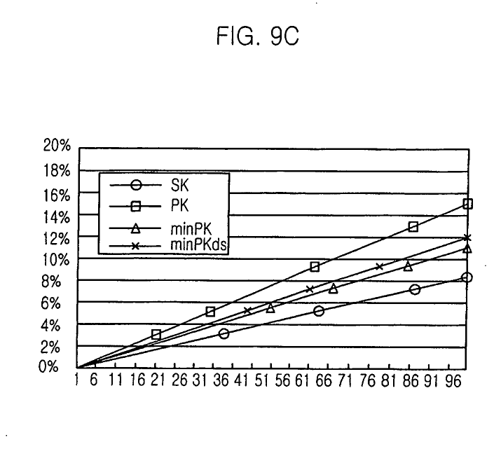

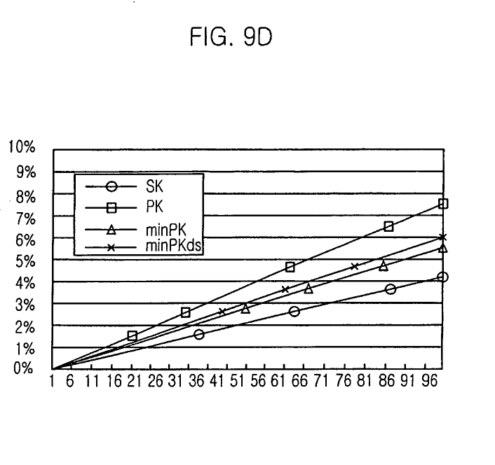

FIG. 9A is a graph showing the period that is required for authentication when the mobile node moves away from 1 km spot from the home network to 40 km spot from the home network.

As the mobile node moves away from 1 km spot from the home agent to 40 km spot from the home agent, the registration time for the private key increases 13 times but the actual registration time is only 420 ms. To the contrary, the registration time for the public key increases 4 times but the entire authentication time is more than 4 seconds. On the other hand, the registration time for the minimal public key is less than a half of the registration time for the public key. The method of present invention shows similar result to the minimal public key based method. Accordingly, it can be seen that the method of the present invention is proper to use as the mobile node moves away from the home agent.

When the size of the subnet is within the range of 0.1 km to 1 km, the period during which the mobile node keeps staying within the subnet is given depending on the moving speed of the mobile node. The size of the subnet changes from 0.1 km of a micro cell to 1 km or more of a macro cell. It is assumed that the moving speed of the mobile node is 1-2 km/h when walking.

FIG. 9B is a graph illustrating a percentage of the authentication period to the stay period during which the mobile node keeps staying within the subnet having its size of 0.1 km.

In the case of 0.1 km subnet size, the percentage of the authentication period to the entire staying time is high. Particularly, as the moving speed increases, that percentage rapidly increases. In the actual Mobile IP, it takes long time to authenticate the new location information and performs tunneling to receive datagram when the mobile node enters the new subnet. Therefore, the percentage of the authentication period should be reduced. However, if the mobile node moves into another subnet even before it completes the authentication and the tunneling processes and receives the tunneled datagram, the overhead for the authentication and tunneling becomes so high as to leave the datagram receiving time too short. In this case, it is important to make the authentication period shorter and it is desirable to use the private key, which cause least deterioration on the performance.

FIG. 9C is a graph demonstrating a percentage of the authentication period to the stay period during which the mobile node keeps staying within the subnet having its size of 0.5 km and FIG. 9D is a graph showing a percentage of the authentication period to the stay period during which the mobile node keeps staying within the subnet having its size of 1 km.

In the case of the subnet size 0.5 km shown in FIG. 9c, the private key can be used when the mobile node moves with speed of 20-30 km, but it is desirable to use the method of the present invention when the mobile node moves with higher speed than that speed, with obtaining desired services and reducing performance deterioration. However, in the case of the subnet size 1 km, the percentage of the authentication period to the staying time within the subnet is maintained less than 8% even if the moving speed increases to 100 km/h. The private key can be used until the mobile node moves in speed 50 km/h. As such, referring to the condition of the subnet and the mobile node, the desirable authentication mechanism may be selected depending on the security and the performance of the authentication mechanism.

As described above, the method of the present invention can be implemented as a program stored in a recordable medium, such as a CD-ROM, a RAM, a ROM, a floppy disk, a hard disk, an optical magnetic disk and the like, in a computer readable form, for which the detailed description will be omitted since those skilled in the art will readily practice such a procedure.

As described above, the present invention can reduce load on the mobile node while providing a non-repudiation function, by adding the electronic signature to the registration request message, which uses the individual certificate of the mobile node.

The present application contains subject matter related to Korean patent application No. 2004-49391, filed in the Korean Patent Office on Jun. 29, 2004, the entire contents of which being incorporated herein by reference.

While the present invention has been described with respect to the particular embodiments, it will be apparent to those skilled in the art that various changes and modifications may be made without departing from the spirit and scope of the invention as defined in the following claims.

1. An authentication method for supporting a Mobile Internet Protocol (IP) system for use in a network system comprising a plurality of agents and a mobile node, comprising:
at the mobile node, receiving an advertisement message from one of the plurality of the agents; and
at the mobile node, transmitting a registration request along with an electronic signature to the agent from which the advertisement message was received.

2. The authentication method as recited in claim 1, wherein the electronic signature is generated based on a private key of the mobile node.

3. The authentication method as recited in claim 1, wherein the electronic signature is generated while the mobile node is in an off-line state for the network system.

4. The authentication method as recited in one of claim 1, wherein the mobile node has a pre-issued certificate.

5. An authentication method for supporting a Mobile Internet Protocol (IP) for use in a network system having a plurality of agents and a mobile node, comprising:
at a first agent among the plurality of the agents, receiving a registration request along with an electronic signature from the mobile node;
at the first agent, verifying the electronic signature in response to the registration request and generating a verification result based on the verification.

6. The authentication method of claim 6, wherein the first agent generates a registration identification (ID) for the mobile node and stores the registration ID.

7. The authentication method as recited in claim 5, wherein the verification result indicates completion of verification and is stored in a memory in the first agent.

8. The authentication method as recited in claim 5, further comprising, at the first agent, transmitting a registration response to the mobile node, wherein the registration response contains a certification code using a private key.

9. The authentication method as recited in claim 5, further comprising:
at a second agent among the plurality of the agents, receiving the registration request along with the electronic signature from the mobile node;
at the second agent, receiving information containing the electronic signature and the verification result from the first agent; and
at the second agent, generating a registration ID for the mobile node and storing the registration ID when the electronic signature from the mobile node and the electronic signature from the first agent are identical and the verification result ensures completion of verification.

10. A mobile electronic device for use with a wireless communication network supporting a Mobile Internet Protocol (IP), comprising:
a receiver configured to wirelessly receive an advertisement message from an agent of the wireless communication network; and
a transmitter configured to transmit a registration request and an electronic signature to the agent.

11. The mobile electronic device as recited in claim 10, wherein the electronic signature is generated based on a private key of the mobile device.

12. The mobile electronic device as recited in claim 10, wherein the electronic signature is generated while the mobile device is in an off-line state for the network system.

13. The mobile electronic device as recited in one of claim 10, wherein the mobile device has a pre-issued certificate.

14. A wireless communication device for use in a wireless communication network supporting a Mobile Internet Protocol (IP), the device comprising:
a receiver configured to receive a registration request along with an electronic signature from a mobile node of the network;
a verifier configured to verify the electronic signature in response to the registration request; and
an ID generator configured to generate a registration identification (ID) for the mobile node and store the registration ID.

15. The wireless communication device as recited in claim 14, wherein the verification result indicates completion of verification and is stored in a memory within the device.

16. The wireless communication device as recited in claim 14, further comprising a transmitter configured to transmit a registration response to the mobile node, wherein the registration response contains a certification code using a private key.

17. The wireless communication device of claim 14, wherein the verifier is configured to conduct an independent verification of the electronic signature, and wherein the verifier is further configured to generate a verification result based on the independent verification.

18. The wireless communication device as recited in claim 14, wherein the receiver is further configured to receive, from another communication device, an electronic signature and a verification result for the mobile node, wherein the verifier is configured to compare the electronic signatures received from the mobile node and from the other device, and wherein the verifier is further configured to generate a registration ID for the mobile node when the electronic signatures from the mobile node and the other device are identical and the verification result ensures completion of verification.
